(19) United States
(12) Patent Application Publication
(10) Pub. No.: US 2006/0028692 A1
(43) Pub. Date: Feb. 9, 2006

(54) Network facsimile apparatus

(76) Inventor: Tomohito Kajiwara, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/190,824

(22) Filed: Jul. 28, 2005

(30) Foreign Application Priority Data
Aug. 9, 2004 (JP) 2004-232145

(51) Int. Cl. H04N 1/00

(52) U.S. Cl. 358/402; 358/400

(57) ABSTRACT

A network facsimile apparatus that performs a direct facsimile communication as a sender terminal with a receiver terminal via a network includes a flow control unit that stops transmission of data, when an amount of data transmitted from the sender terminal exceeds an amount of data that can be processed by the receiver terminal, until the receiver terminal becomes ready to receive the data.

### CROSS-REFERENCE TO RELATED APPLICATIONS

The present document incorporates by reference the entire contents of Japanese priority document, 2004-232145 filed in Japan on Aug. 9, 2004.

### BACKGROUND OF THE INVENTION

1. Field of the Invention

The present invention relates to technology for performing direct facsimile communication through a network.

2. Description of the Related Art

Network facsimile terminals that are compliant with the International Telecommunication Union (ITU) recommendation T.38 (hereinafter, “T.38 terminal”) can perform high-speed facsimile communication through a network such as the Internet. The T.38 terminal is being widely used instead of a conventional low-speed Group 3 (G3) facsimile apparatus that communicates through an analogy telephone line. The T.38 terminal is disclosed in, for example, Japanese Patent Application Laid Open No. 2001-197249 and Japanese Patent Application Laid Open No. 2001-309112. There are two types of T.38 terminals. The first is a direct-connection type; specifically, a sending T.38 terminal directly communicates with a receiving T.38 terminal through a network. The second is a gateway device that simultaneously communicates with a G3 facsimile apparatus through a public telephone network and with a T.38 terminal; the gateway device functions as an intermediate device between the G3 facsimile apparatus and the T.38 terminal.

The T.38 terminals that are direct-connection type Internet Aware Fax (IAF) terminals can directly communicate with each other through a local area network (LAN), without using the G3 facsimile apparatus. The IAF terminals can communicate with each other at a higher speed than that specified for the G3 facsimile apparatus. However, the communication speed needs to be negotiated between the receiver terminal and the sender terminal. The problem with the conventional technology is that it is difficult to negotiate and determine an optimal communication speed according to a processing capacity of the receiver terminal.

### SUMMARY OF THE INVENTION

It is an object of the present invention to at least solve the problems in the conventional technology.

A network facsimile apparatus according to one aspect of the present invention, which performs a direct facsimile communication as a sender terminal with a receiver terminal via a network, includes a flow control unit that stops transmission of data, when an amount of data transmitted from the sender terminal exceeds an amount of data that can be processed by the receiver terminal, until the receiver terminal becomes ready to receive the data.

The above and other objects, features, advantages and technical and industrial significance of this invention will be better understood by reading the following detailed description of presently preferred embodiments of the invention, when considered in connection with the accompanying drawings.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram of a facsimile communication system employing direct-connection type IAF T.38 terminals according to the present invention;

FIG. 2 is a chart of a communication sequence between a sender terminal and a receiver terminal;

FIG. 3 is a flowchart of operations according to a first embodiment of the present invention;

FIG. 4 is a flowchart of operations according to a second embodiment of the present invention; and

FIG. 5 is a flowchart of operations according to a third embodiment of the present invention.

### DETAILED DESCRIPTION OF THE PREFERRED EMBODIMENTS

Exemplary embodiments of the present invention will be described below with reference to accompanying drawings. The present invention is not limited to these embodiments.

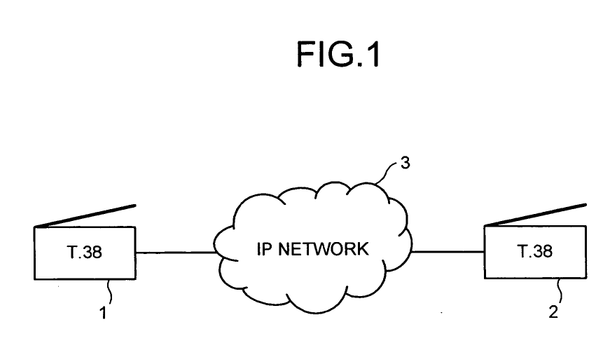

FIG. 1 is a block diagram of a facsimile communication system employing direct-connection type IAF T.38 terminals according to the present invention. A sender terminal 1 and a receiver terminal 2 directly communicate with each other through an Internet protocol (IP) network 3.

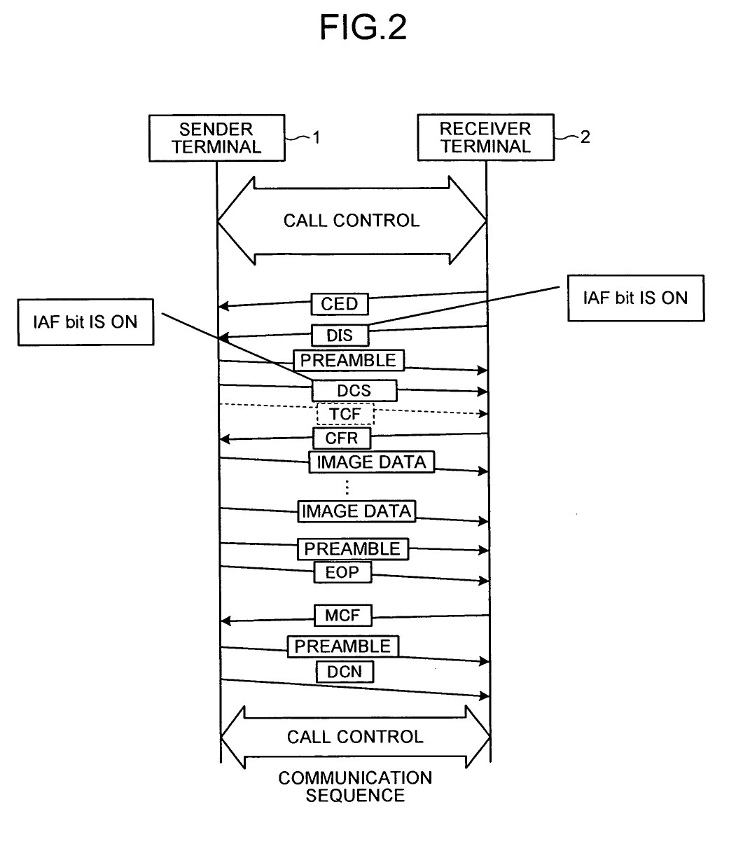

FIG. 2 is a chart of a communication sequence between the sender terminal 1 and the receiver terminal 2. First, a call control is performed. Next, predetermined signals are sent to each other, such as a called station identifier (CED) tone, a digital information signal (DIS), a digital command signal (DCS), a training check message (TCF), and a confirmation to receive (CFR). Next, the sender terminal 1 sends image data to the receiver terminal 2. Next, predetermined signals are sent to each other, such as an end of procedure (EOP) signal, a message confirmation signal (MCF), and a disconnect message (DCN). Next, the call control is performed. If a predetermined bit (IAF bit in FIG. 2) is “ON” for the signals such as DIS or DCS, it indicates that the terminal is a direct-connection type IAF terminal.

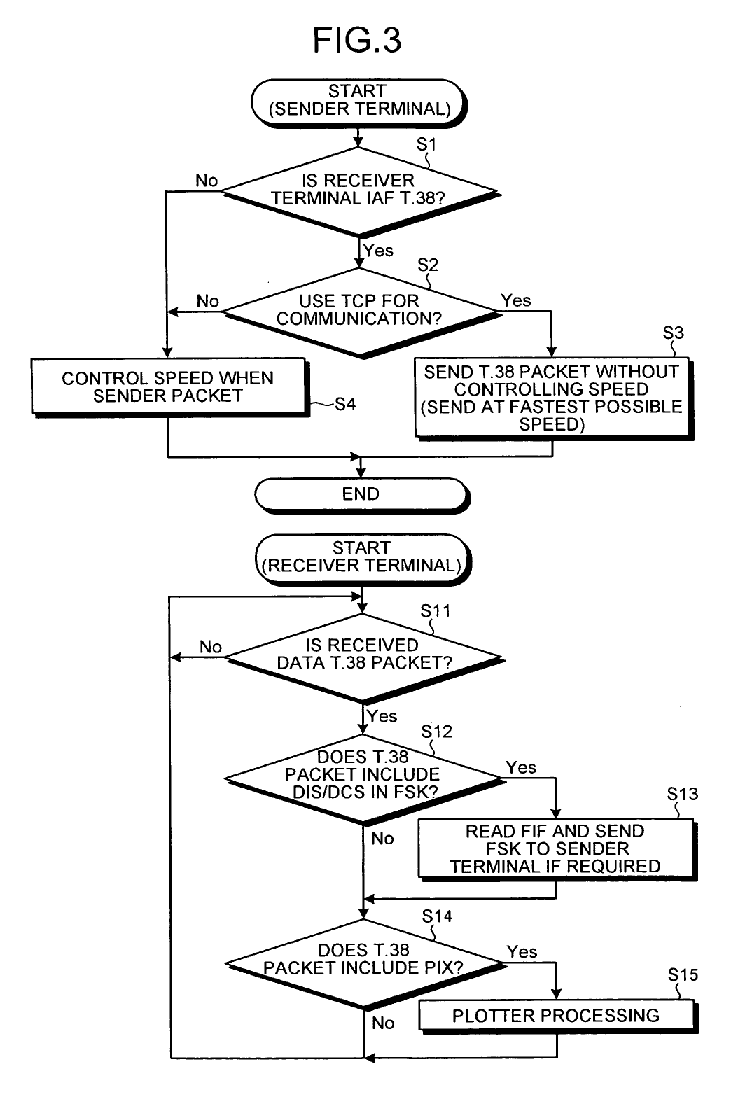

FIG. 3 is a flowchart of operations performed by the sender terminal 1 and the receiver terminal 2 according to a first embodiment of the present invention.

The sender terminal 1 determines whether a destination terminal (the receiver terminal 2) is a direct-connection type IAF T.38 terminal (step S1, hereinafter omitting “step”). If the destination terminal is a direct-connection type IAF T.38 terminal, the sender terminal 1 negotiates with the receiver terminal 2 to determine a T.38 communication control protocol. If the protocol is determined to be a transmission control protocol (TCP) (Yes at S2), the sender terminal 1 sends a T.38 packet at a highest possible transmission speed without controlling the transmission speed (S3). If it is determined that the destination terminal is not a direct-connection type IAF T.38 terminal at S1, or if the protocol determined at S2 is not TCP (e.g. user datagram protocol (UDP)), the sender terminal 1 controls the transmission speed when sending the T.38 packet at S4.

The receiver terminal 2 determines whether data received is a T.38 packet (S1). If the data is a T.38 packet, the receiver terminal 2 determines whether the data includes, DIS, DSC signals that indicate that the data is not image data, in frequency shift keying (FSK) (S12). If DIS, DSC signals are found, the receiver terminal 2 reads a fax information field (FIF), and sends the FSK to the sender terminal 1, if required (S13). After S13, or if DIS, DSC signals are not found at S12, the receiver terminal 2 determines whether the data received includes a PIX signal indicating that the data is image data (S14). If a PIX signal is found, the receiver terminal 2 performs plotter processing (S15). The system control then returns to S11, and receives the next T.38 packet. If a PIX signal is not found at S14, the system control returns to S11.

Accordingly, the receiver terminal 2 is able to receive a T.38 packet sent at high speed from the sender terminal 1 that is a direct-connection type IAF T.38 terminal. Specifically, the receiver terminal 2 decodes the T.38 packet received, performs a series of processings on the T.38 packet, and then receives the next T.38 packet.

According to the first embodiment, the sender terminal 1 sends the T.38 packet at the highest possible transmission speed without controlling the communication speed at S3. However, the TPC has a flow control function. Specifically, when a packet amount being sent from the sender terminal 1 exceeds a packet amount that can be processed by the receiver terminal 2, the flow control function suspends the transmission, until the receiver terminal 2 is ready. Thus, even if the sender terminal 1 sends packets at the highest possible speed, the flow control function is automatically activated. As a result, high-speed communication is performed at an optimal speed according to a processing capacity of the receiver terminal 2.

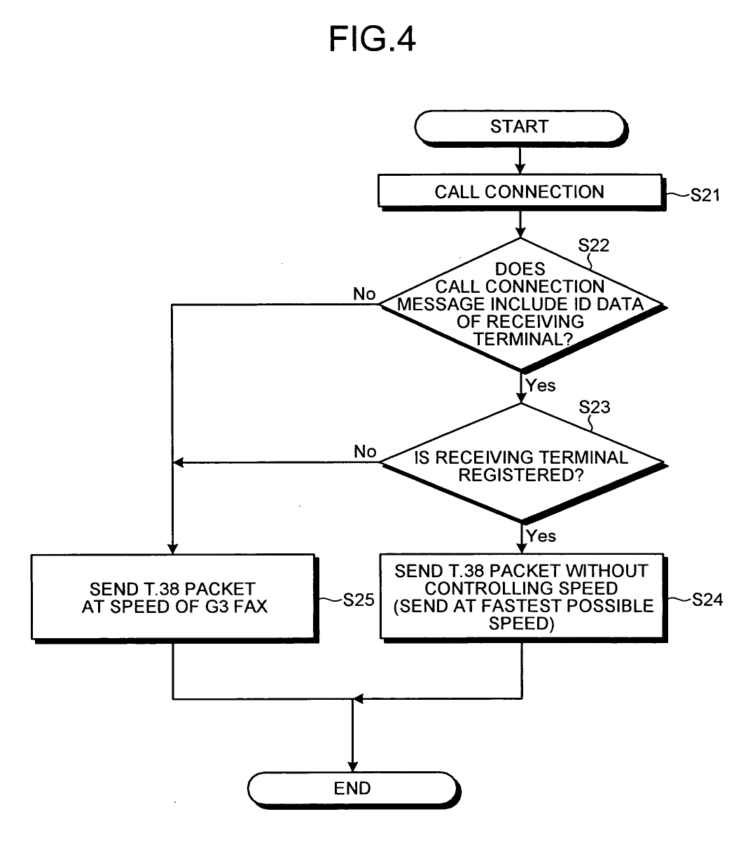

FIG. 4 is a flowchart of operations performed by the sender terminal 1 according to a second embodiment of the present invention.

First, the sender terminal 1 makes a call connection to the receiver terminal 2 (S21). The sender terminal 1 determines whether a call connection message received from the receiver terminal 2 includes identification (ID) data of the receiver terminal 2 (S22). If ID data is included, the sender terminal 1 determines whether the ID data is that of a registered T.38 terminal (S23). If the ID data is registered, the sender terminal 1 sends a T.38 packet at a highest possible transmission speed without controlling the transmission speed, similarly to S3 in FIG. 3 (S24). Moreover, if registered ID data is not found at S22 or S23, the sender terminal 1 controls the speed when sending the T.38 packet to the receiver terminal 2. In this case, T.38 packet is sent at a speed as low as that of a G3 facsimile apparatus (S25).

The sender terminal 1 determines a machine model of the receiver terminal 2 before sending the T.38 packet, in sequences of an H.323 call control and a session initiation protocol (SIP) call control. When the receiver terminal 2 is an IAF, the sender terminal 1 performs the same communication method as that of the first embodiment. Accordingly, the flow control function is automatically activated so that high-speed communication is performed at an optimal speed according to a processing capacity of the receiver terminal 2.

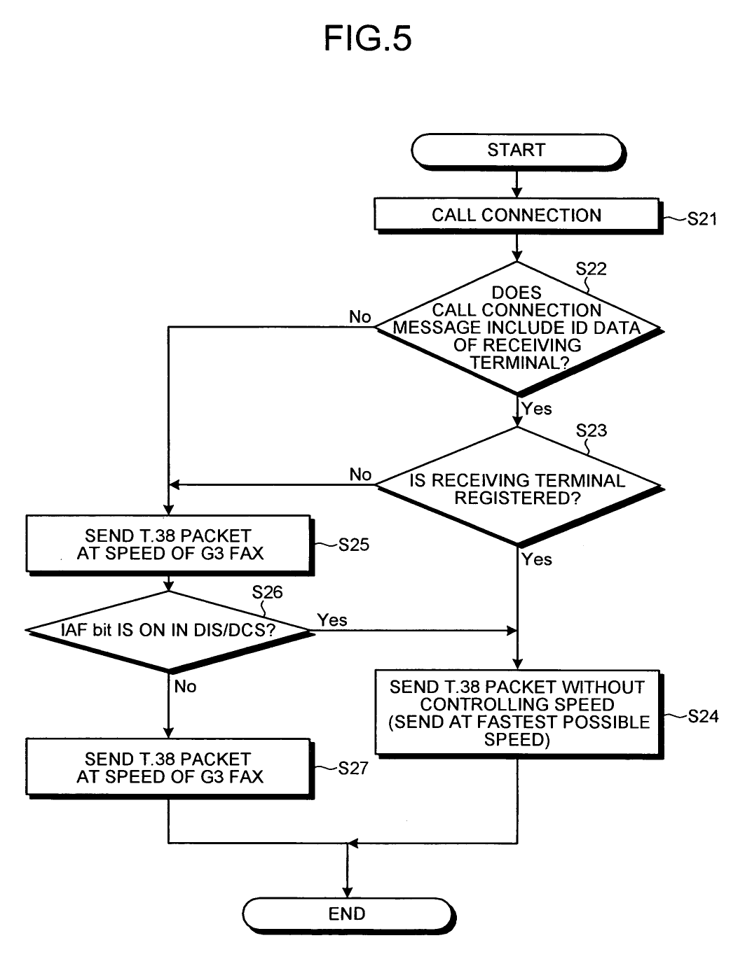

FIG. 5 is a flowchart of operations performed by the sender terminal 1 according to a third embodiment of the present invention. The processings of S21 to S25 are the same as those of FIG. 4. When the sender terminal 1 is controlling the speed when sending the T.38 packet to the receiver terminal 2 at S25, and if the IAF bit turns “ON” for the signals of DIS and DCS (S26), the sender terminal 1 reduces the speed of the T.38 to that of a G3 facsimile apparatus at S27, similarly to S25.

According to the present invention, a direct-connection type IAF terminal can send data at a highest possible speed, by using a protocol such as TCP that has a flow control function. Thus, high-speed facsimile communication is performed at an optimal speed according to a processing capacity of a receiver terminal

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A network facsimile apparatus that performs a direct facsimile communication as a sender terminal with a receiver terminal via a network, the network facsimile apparatus comprising a flow control unit that stops transmission of data, when an amount of data transmitted from the sender terminal exceeds an amount of data that can be processed by the receiver terminal, until the receiver terminal becomes ready to receive the data.

2. The network facsimile apparatus according to claim 1, further comprising:
an identification acquiring unit that acquires identification data for identifying the receiver terminal at a time of a call connection with the s receiver terminal; and
a determining unit that determines whether to activate the flow control unit based on the identification data acquired.

3. The network facsimile apparatus according to claim 1, wherein
a digital information signal/digital command signal that is communicated at a time of a call connection with the receiver terminal includes a predetermined bit, and
the flow control unit is activated when the predetermined bit is on.

4. The network facsimile apparatus according to claim 1, wherein the sender terminal and the receiver terminal are direct-connection type internet-aware-facsimile terminals that are compliant with the International Telecommunication Union recommendation T.38.
